(19) United States
(12) Patent Application Publication
(10) Pub. No.: US 2026/0226249 A1
(43) Pub. Date: Aug. 6, 2026

(54) PROCESS FOR DEPOLYMERIZATION OF POLYALKYLENE TEREPHTHALATES IN AN EXTRUDER

(71) Applicant: Evonik Operations GmbH, Essen (DE)

(72) Inventors: Dirk ROETTGER, Köln (DE); Christian ZANDER, Hanau (DE); Philip Heinrich REINSBERG, Rheinbach (DE); Johannes RUWWE, Hanau (DE); Thomas RICHTER, Darmstadt (DE)

(73) Assignee: Evonik Operations GmbH, Essen (DE)

(21) Appl. No.: 19/149,113

(22) PCT Filed: Jan. 17, 2024
(86) PCT No.: PCT/EP2024/051049

§ 371 Date: Jul. 18, 2025

(30) Foreign Application Priority Data
Jan. 23, 2023 (EP) 23152836.5

(51) Int. Cl. C08J 11/24

(52) U.S. Cl. CPC C08J 11/24; C08J 2367/02

(57) ABSTRACT

The invention relates to an improved process for depolymerization of at least one polymer P₁ which is a polyalkylene terephthalate, i.e. a polymer comprising terephthalic acid units and alkylene glycol units, in particular polyethylene terephthalate PET or polybutylene terephthalate PBT. The process is particularly suitable for depolymerization and for recycling of PET-containing wastes.

The process is performed in an extruder E having at least two barrels G₁, G₂, wherein the at least one polymer P₁ is provided in barrel G₁ as suspension S₁. The suspension S₁ is then transported into the barrel G₂ and there at least one glycol compound G, preferably ethylene glycol, is added to the suspension S₁. The at least one glycol compound G reacts in the suspension S₁ with the at least one polymer P₁ to afford a mixture M_{G2} comprising the corresponding cleavage products P₂. The resulting mixture M_{G2} is transported to the product outlet E_{X} of the extruder E. At the product outlet E_{X} a portion of M_{G2} is withdrawn and utilized as the continuous phase P_{Kon} of the suspension S₁ provided in G₁.

The process allows for a safer process mode since it avoids the uncontrolled increase in temperature and pressure during depolymerization of the polymer P₁.

The invention relates to a process for depolymerization of at least one polymer P₁ which is a polyalkylene terephthalate, i.e. a polymer comprising terephthalic acid units and alkylene glycol units, in particular polyethylene terephthalate PET or polybutylene terephthalate PBT. The process is particularly suitable for depolymerization and for recycling of PET-containing wastes.

The process is performed in an extruder E having at least two barrels G₁, G₂, wherein the at least one polymer P₁ is provided in barrel G₁ as suspension S₁. The suspension S₁ is then transported into the barrel G₂ and there at least one glycol compound G, preferably ethylene glycol, is added to the suspension S₁. The at least one glycol compound G reacts in the suspension S₁ with the at least one polymer P₁ to afford a mixture M_{G2} comprising the corresponding cleavage products P₂. The resulting mixture M_{G2} is transported to the product outlet E_{X} of the extruder E. At the product outlet E_{X} a portion of M_{G2} is withdrawn and utilized as the continuous phase P_{Kon} of the suspension S₁ provided in G₁.

The process allows for a safer process mode since it avoids the uncontrolled increase in temperature and pressure during depolymerization of the polymer P₁.

### BACKGROUND OF THE INVENTION

Polyethylene terephthalate (=“PET”) is one of the most important plastics which is used in textile fibres, as films, and as material for plastic bottles. In 2007 alone, the volume used in plastic bottles was ~10⁷ t (W. Caseri, Polyethylenterephthalate, RD-16-03258 (2009) in F. Böckler, B. Dill, G. Eisenbrand, F. Faupel, B. Fugmann, T. Gamse, R. Matissek, G. Pohnert, A. Rühling, S. Schmidt, G. Sprenger, RÖMPP [Online], Stuttgart, Georg Thieme Verlag, January 2022).

On account of its persistence and the volumes of refuse originating from PET, it constitutes one of the greatest environmental challenges at present. A similar problem also exists for other polyalkylene terephthalates similar to PET, for example polybutylene terephthalate (“PBT”).

The solution to this problem lies in the avoidance and in the efficient reutilization of these plastics.

The prior art proposes multiple processes for cleavage of PET.

GB 784,248 A describes the methanolysis of PET.

Hydrolytic processes for depolymerization of PET are described by JP 2000-309663 A, U.S. Pat. No. 4,355,175 A and T. Yoshioka, N. Okayama, A. Okuwaki, Ind. Eng. Chem. Res. 1998, 37, 336-340.

The reaction of PET with glycol compounds is described in U.S. Pat. No. 3,884,850, EP 0 723 951 A1, U.S. Pat. No. 3,222,299 A, WO 2020/002999 A2, in S. R. Shukla, A. M. Harad, Journal of Applied Polymer Science 2005, 97, 513-517 (hereinbelow “Shukla & Harad”) and in N. D. Pingale, S. R. Shukla, European Polymer Journal 2008, 44, 4151-4156.

Shukla & Harad state that PET glycolysis forms bis(2-hydroxyethyl) terephthalate (=“BHET”). This cleavage product may simultaneously be used as starting material for production of new PET.

S. Ügdüler, K. M. Van Geem, R. Denolf, M. Roosen, N. Mys, K. Ragaert, S. De Meester, Green Chem. 2020, 22, 5376-5394 (“Ügdüler et al.”) investigate the aqueous alkaline hydrolysis of PET wastes to afford ethylene glycol and terephthalic acid (=TS), in particular the influence of certain reaction parameters such as temperature, ethanol/water ratio etc. on the rate of depolymerization. Ügdüler et al. also discuss the problem of contamination of the PET starting material with additional polymers such as low-melting polyolefins (“polyolefin” is abbreviated as “PO” below).

In addition to these processes there is a multiplicity of processes in which PET-containing wastes are cleaved in an extruder and then worked up.

U.S. Pat. No. 5,545,746 A describes the depolymerization of PET wastes in an extruder to afford ethylene glycol and TS.

L. Biermann, E. Brepohl, C. Eichert, M. Paschetag, M. Watts, S. Scholl, Green Process. Synth. 2021, 10, 361-373 (“Biermann et al.”), which refer to U.S. Pat. No. 5,545,746 A, and WO 2020/053051 A1 describe the hydrolysis of mixed wastes (PET/PE) to afford ethylene glycol and terephthalic acid (=“TS”) in the twin-screw extruder using solid sodium hydroxide.

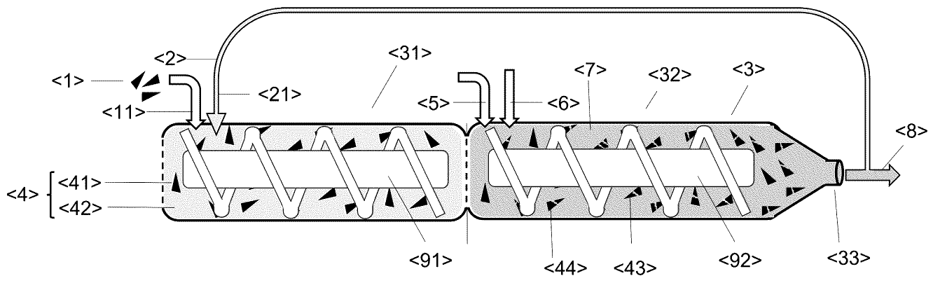

WO 2020/053051 A1 describes in detail the saponification (page 8, line 1 of WO 2020/053051 A1), i.e. the hydrolysis, of PET using alkali metal or alkaline earth metal hydroxides, wherein ethylene glycol as solvent is additionally supplied to the reaction mixture as a stream separate from the alkali metal/alkaline earth metal hydroxide stream (see FIG. 1; example 2, page 19, lines 25 to 28; example 4, page 20, lines 27 to 28 of WO 2020/053051 A1). Biermann et al. also disclose the saponification of PET.

M. A. Mohsin, T. Abdulrehman, Y. Haik, Int. J. Chem. Eng. 2017, 5361251 (“Mohsin et al.”) describe the reaction of molten PET with ethylene glycol in an extruder. Mohsin et al, however do not describe the use of ethyleneglycolate nor the presence of additional polymers in the PET.

B. Bergmann, W. Becker, J. Diemert, P. Elsner, Macromol. Symp. 2013, 333, 138-141 (“Bergmann et al.”) describe the reaction of molten PET with ethylene glycol in an extruder and the analysis of the extrusion product by near-infrared spectroscopy. The reaction is the same as that described by Mohsin et al.

U. Thiele presented a corresponding process for PET glycolysis in the extruder at the “5th China International Recycled Polyester Forum”, which took place from 2 to 4 Sep. 2009 in Shanghai, China, in the context of an overview of various processes for PET depolymerization. The corresponding presentation is retrievable from http://www.ccfei.net/upfile/conference/200909181532368708140.pdf (“Thiele”), last retrieved 15 Jan. 2023.

J. D. Patterson discloses, on pages 60 ﬀ. of the thesis “Continuous Depolymerization of Poly (ethylene terephthalate) via Reactive Extrusion” (North Carolina State University, 28 Mar. 2007, retrievable from https://repository.lib.ncsu.edu/bitstream/handle/1840.16/3783/etd.pdf?sequence=1; “Patterson”, last retrieved 15 Jan. 2023) a process for PET glycolysis in the extruder. This too employs ethylene glycol but not ethyleneglycolate. Patterson also quotes the article by G. Colomines, F. Rivas, M.-L. Lacoste, J.-J. Robin, Macromolecular Materials and Engineering 2005, 290, 710-720 (“Colomines et al.”). It describes the glycolysis of PET with diethylene glycol and the use of the reaction product in polyurethane formulations.

M. Dannoux, P. Cassagnau, A. Michel, Can J Chem Eng 2002, 80, 1075-1082 describe the alcoholysis of PET in an extruder using dibutyltin oxide as catalyst.

U.S. Pat. No. 3,884,850 describes a system for depolymerization of PET in which PET is converted into BHET and low molecular weight oligomers of BHET. This process is not performed in an extruder.

The cleavage of polyesters, for example polyalkylene terephthalates, in apparatuses typical for polymer processing, for example extruders, is typically performed above the melting temperature of the polyester to plasticize the material.

However, particularly the glycolysis of polyalkylene terephthalates such as PET suffers from the problem that the melting temperature thereof is above the boiling temperature of ethylene glycol. In the course of glycolysis, the resulting vapour pressure of the glycol compound results in pulsations and unstable operating states of the reactor. Accordingly only very small amounts of the glycol compound may be employed, which leads to the formation of oligomeric melts with relatively high viscosity, or the extruder must be operated with a pressure maintenance means to compensate the vapour pressure of the glycol compound, in particular of the ethylene glycol.

This disadvantage is particularly important when polyalkylene terephthalates, in particular PET and PBT, are to be cleaved to afford the corresponding cleavage products such as for example BHET, since this reaction is typically performed with a large excess of ethylene glycol, often with the addition of catalysts such as ethyleneglycolates or alkoxides of monohydric C₁-C₆-alkyl alcohols.

It was accordingly the object of the present invention to provide an efficient process for depolymerization of polyalkylene terephthalates, in particular PET and PBT, in the extruder which does not have the above-mentioned disadvantages and in particular ensures a safe process mode without pressure spikes. This process shall ensure these advantages, especially in glycolytic depolymerization.

### BRIEF DESCRIPTION OF THE INVENTION

It has now been found that, surprisingly, the depolymerization of polyalkylene terephthalates in extruders using glycol compounds may be performed without the above-described disadvantages (inhomogeneous process mode, build-up of pressure spikes) when the relevant polyester is employed in the form of a suspension. In this suspension polyalkylene terephthalate is present as a solid phase in particle form while a portion of the product mixture withdrawn at the outlet of the extruder serves as the continuous, liquid phase.

### FIGURE

The FIGURE shows an embodiment of the process according to the invention. This is performed in an extruder E <3> having two barrels G₁ <31> and G₂ <32> and a product outlet E_{X} <33>. The extruder E <3> is a twin-screw extruder, wherein each barrel G₁ <31> and G₂ <32> comprises a respective screw element <91> and <92>.

PET particles Pₚₐᵣ <41> and a mixture <2> serving as the continuous phase P_{Kon} <42> are passed separately as material stream <11> and material stream <21> into G₁ <31>. Alternatively, the two material streams <11> and <21> may also be mixed before they are passed into G₁ <31> as a mixed stream.

The temperature in G₁ <31> is adjusted such that P_{Kon} <42> is in the liquid state while PET <41> is in the solid state. The mixing and kneading function of the screw element <91> helps to ensure that the mixture <2> forms a continuous phase P_{Kon} <42> in which the PET particles Pₚₐᵣ <41> are suspended. PET <1> is introduced into the barrel G₁ <31> in the form of particles Pₚₐᵣ <41>. Additional comminuting elements in the barrel G₁ <31> may be used here to further comminute the particles Pₚₐᵣ <41> or, if the PET starting material <1> is employed in uncomminuted form, to ensure sufficient comminution in the barrel G₁ <31>. The resulting suspension S₁ <4> is mixed by the screw element <91> so that a uniform distribution of the PET particles Pₚₐᵣ <41> in P_{Kon} <42> is achieved. Simultaneously S₁ <4> is transported (or else “conveyed”) by the screw element <91> in the direction of the barrel G₂ <32> and thus in the direction of the product outlet E_{X} <33> (“downstream”).

In the barrel G₂ <32> S₁ <4> is mixed with a stream <5> of ethylene glycol and a stream <6> of a 30% by weight solution of sodium methoxide in methanol (solid sodium methoxide is also alternatively employable) to afford a suspension S₁ <7> comprising PET <1> in which the content of glycol, sodium methoxide and methanol is elevated relative to the suspension S₁ <4> in the barrel G₁ <31>. Suspension S₁ <7> is converted into the mixture M_{G2} <8> upon passing through the barrel G₂ <32>. PET <1> is reacted with ethylene glycol and methoxide to afford the product BHET <43> and oligomers of BHET <44> in a cleavage reaction. A mixture M_{G2} <8> comprising BHET, oligomers of BHET and ethylene glycol is thus obtained at the product outlet E_{X} <33>. In the embodiments of the present invention in which the cleavage reaction of the PET <1> in the barrel G₂ <32> proceeds incompletely, M_{G2} <8> still also comprises a proportion of PET <1>. A portion of the mixture M_{G2} <8> withdrawn at the product outlet E_{X} <33> is then reintroduced into the barrel G₁ <31> as mixture <2> and serves as continuous phase P_{Kon} <42> in the suspension S₁<4>.

Since the PET particles Pₚₐᵣ <41> are present in suspended form in the phase P_{Kon} <42> and a portion of the obtained mixture M_{G2} <8>, which is the product of the reaction, is used as continuous phase P_{Kon} <42>, the reaction conditions are equalized and pressure and temperature spikes in the extruder E <3> are avoided. This makes the entire process safer to perform and thus more efficient and the glycolysis of PET <1> proceeds in a controlled manner.

In an alternative embodiment according to the invention a further barrel G₃ having a screw element corresponding to the screw elements <91>, <92> is arranged between the barrel G₂ <32> and the product outlet E_{X} <33>. The suspension S₁ <7> or the mixture M_{G2} <8> obtained upon advancement of the reaction pass through this barrel G₃ during transport from G₂ <32> to the product outlet E_{X} <33>.

### DETAILED DESCRIPTION OF THE INVENTION

The process according to the invention is a process for depolymeriation of at least one polymer P₁.

The compounds BHET, MHET, TS mentioned in the context of the present invention have the following structures:

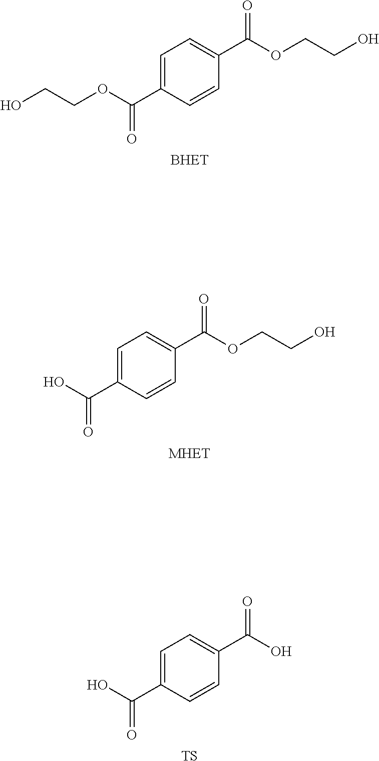

“MHET” also encompasses the corresponding carboxylate of the structure shown.

“TS” also encompasses the corresponding mono- and dicarboxylate of the structure shown.

### 1. Polymer P₁

The at least one polymer P₁ comprises n₁ interlinked repeating units of the following structural formula (I):

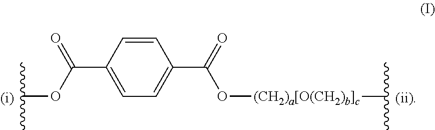

Here, a is an integer for which 2≤a≤6, in particular a=2 or 4, preferably a=2.

Here, b is an integer for which 2≤b≤6, in particular b=2 or 4, preferably b=2.

Here, c is an integer for which 0≤c≤10, in particular c=0 or 1, preferably c=0.

Here, n₁ is an integer ≥50.

The n₁ interlinked repeating units of structural formula (I) comprised by the polymer P₁ are identical or different here, in particular identical.

The n₁ interlinked repeating units of structural formula (I) are interlinked here within the polymer P₁ in such a way that the bond of the one repeating unit of structural formula (I) labelled “(i)” is linked to the bond of the adjacent repeating unit of structural formula (I) labelled “(ii)”.

The process according to the invention is particularly suitable for depolymerization of polymers P₁ which at least in part comprise segments of polyethylene terephthalate [“PET”; following option (β)] or segments of polybutylene terephthalate [“PBT”; following option (α)].

Preference is therefore given to one of the following embodiments (α), (β), wherein (β) is more preferred:
(a) The polymer P₁ comprises n₁ interlinked repeating units of structural formula (I), wherein a=4, c=0.
(B) The polymer P₁ comprises n₁ interlinked repeating units of structural formula (I), wherein a=2, c=0.

The end group of the first repeating unit of the n₁ interlinked repeating units of the polymer P₁ which is present for said units in the structural formula (I) at the bond defined by “(i)”, and the end group of the n₁th repeating unit of the n₁ interlinked repeating units of the polymer P₁ which is present for said units in the structural formula (I) at the bond defined by “(ii)” are not particularly limited and are a consequence of the method used in the production method of the polymer P₁.

Thus, these end groups may be termination fragments of a repeating unit of structural formula (I) or may be one or more repeating units W_{X}, wherein W_{X} is distinct from structural formula (I).

It is preferable when at least one of these two end groups is selected from:
H;
OH;
optionally at least one group selected from aliphatic radical comprising —OH, —O— (which may in particular be a group, optionally at least one group, selected from alkyl group comprising —OH, —O—);
aromatic radical [such as in particular an isophthalic acid radical of the below-mentioned structural formula (VII)];
heteroaromatic radical.

It is more preferable when at least one, preferably both, of these end groups is selected from:
H;
OH;
optionally at least one group selected from alkyl group comprising —OH, —O—;
isophthalic acid radical of the below-mentioned structural formula (VII).

It is more preferable when the end group connected to the bond labelled “(i)” in the structural formula (I) is selected from —H, —(CH₂)_{a*}—[O(CH₂)_{b*}]_{c*}—OH.

Here, a* is an integer for which 2≤a*≤6, in particular a*=2 or 4, preferably a*=2.

Here, b* is an integer for which 2≤b*≤6, in particular b*=2 or 4, preferably b*=2.

Here, c* is an integer for which 0≤c*≤10, in particular c*=0 or 1, preferably c*=0.

Irrespective of this, the end group connected to the bond labelled “(ii)” in the structural formula (I) is preferably selected from the group consisting of —H, —OH, a radical of structural formula (IV) or (VII), more preferably selected from the group consisting of —H, —OH, a radical of structural formula (IV), yet more preferably selected from the group consisting of —OH, a radical of structural formula (IV), wherein the structural formulae (IV) and (VII) are as follows:

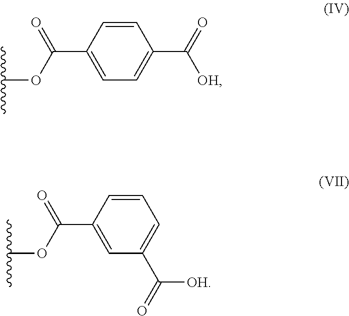

The process according to the invention may thus also be employed for depolymerization of such polymers P₁ which in addition to the n₁ interlinked repeating units of structural formula (I) comprise further repeating units WY distinct therefrom. This is the case for example for polymers P₁ which comprise comonomer units such as in particular repeating units WY of below-mentioned formula (VI) in which a, b, c have the above-mentioned definition:

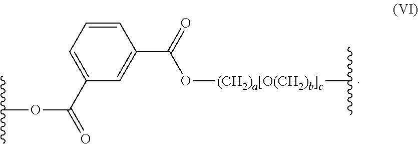

The polymer P₁ according to the present invention thus comprises any polymer comprising at least one segment A₁ which consists of n₁ interlinked repeating units of structural formula (I) which are identical or different, preferably identical, within segment A₁ and wherein the n₁ interlinked repeating units of structural formula (I) are interlinked within segment A1 in such a way that the bond of the one repeating unit of structural formula (I) labelled “(i)” is linked to the bond of the adjacent repeating unit of structural formula (I) labelled “(ii)”.

In addition to the n₁ interlinked repeating units of structural formula (I) the polymer P₁ may comprise further, preferably organic, groups G_{F}, which are not composed of repeating units of structural formula (I), for example oligomer segments or polymer segments composed of repeating units W_{z} distinct from structural formula (I).

For example, a segment A₁ composed of the n₁ interlinked repeating units of structural formula (I) may then be linked with such organic groups G_{F} within the polymer P₁ via bond (i) of the first repeating unit of the n₁ interlinked repeating units of structural formula (I) in segment A₁ and/or via bond (ii) of the n₁th repeating unit of the n₁ interlinked repeating units of structural formula (I) in segment A₁.

Similarly, the polymer P₁ may also comprise two or more segments A1, A2 etc. which are each composed of n₁ interlinked repeating units of structural formula (I) and are connected to one another via organic groups G_{F} distinct from structural formula (I), for example oligomers or polymers composed of repeating units WA distinct from structural formula (I), wherein these organic groups G_{F} bond to bond (ii) of the n₁th repeating unit of the first segment A₁ and bond (i) of the first repeating unit of the following segment A₂.

In a preferred embodiment of the present invention the polymer P₁ has n₁ interlinked repeating units of structural formula (I), wherein the proportion of repeating units of structural formula (I) in the polymer P₁ is ≥50% by weight, in particular ≥60% by weight, preferably ≥70% by weight, more preferably ≥80% by weight, more preferably ≥90% by weight, yet more preferably ≥95% by weight, most preferably ≥99% by weight, in each case based on the molar weight of the polymer P₁.

In the process according to the invention the suspension S₁ provided in step (a) preferably comprises different polymers P₁. The individual polymers P₁ in this embodiment typically have different degrees of polymerization, i.e. n₁ is different for at least a portion of the polymers P₁ comprised in the suspension S₁ provided in step (a).

In a further preferred embodiment of the present invention the suspension S₁ provided in step (a) comprises different polymers P₁, wherein at least 10%, preferably at least 20%, more preferably at least 30%, yet more preferably at least 50%, yet more preferably at least 75%, most preferably at least 99% of all of the polymers P₁ comprised in the suspension S₁ provided in step (a) comprise at least one segment A1 composed of n₁ ≥100 interlinked repeating units of structural formula (I).

In a particularly preferred embodiment of the process according to the invention the at least one polymer P₁ has the structural formula (I′), wherein

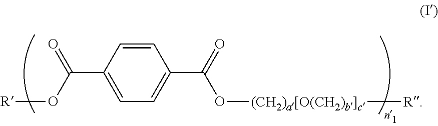

Here, a′ is an integer for which 2≤a′≤6, in particular a′=2 or 4, preferably a′=2.

Here, b′ is an integer for which 2≤b′≤6, in particular b′=2 or 4, preferably b′=2.

Here, c′ is an integer for which 0≤c′≤10, in particular c′=0 or 1, preferably c′=0.

Here, n′1 is an integer ≥49, preferably ≥50.

A polymer P₁ having structural formula (l′) may also be represented as follows:

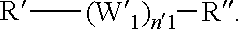

W′₁ thus conforms to the structure comprised in the parentheses indexed with “n′₁” in structural formula (I′). The unit W′₁ thus has the following structure:

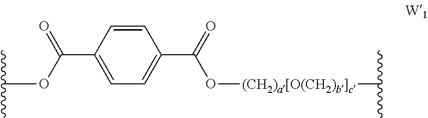

The n′₁ units W′₁ interlinked within the polymer P₁ according to structural formula (I′) are identical or different to one another, in particular identical, within the polymer P₁.

Here, R′ is selected from —H, — [symbol] —[O—( [symbol] —OH.

Here, [symbol] is an integer for which 2≤ [symbol] ≤6, in particular [symbol] =2 or 4, preferably [symbol] =2.

Here, [symbol] is an integer for which 2≤ [symbol] ≤6, in particular [symbol] =2 or 4, preferably [symbol] =2.

Here, [symbol] is an integer for which 0≤ [symbol] ≤10, in particular [symbol] =0 or 1, preferably [symbol] =0.

Here, R″ is selected from the group consisting of —H, —OH, a radical of structural formula (IV) or (VII), preferably selected from the group consisting of —H, —OH, a radical of structural formula (IV), more preferably selected from the group consisting of —OH, a radical of structural formula (IV), wherein the structural formulae (IV) and (VII) are as follows:

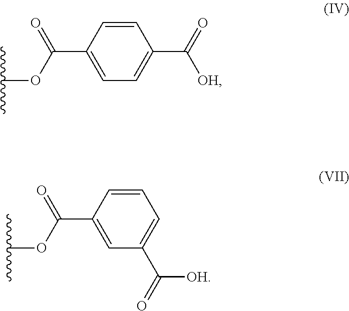

The process according to the invention is especially suitable for depolymerization of polyethylene terephthalate (“PET”) and polybutylene terephthalate (“PBT”). Thus, in a preferred embodiment the polymer P₁ is selected from PET, PBT. The polymer P₁ is most preferably PET.

PBT corresponds to the polymer P₁ according to structural formula (I′), wherein a′=4, c′=0.

PET corresponds to the polymer P₁ according to structural formula (I′), wherein a′=2, c′=0.

In the process according to the invention the suspension S₁ provided in step (a) preferably comprises different polymers P₁ according to structural formula (I′). The individual polymers P₁ in this embodiment typically have different degrees of polymerization, i.e. n′₁ is different for at least a portion of the polymers P₁ according to structural formula (I′) comprised in the suspension S₁ provided in step (a).

In a further preferred embodiment of the present invention the suspension S₁ provided in step (a) comprises different polymers P₁ of structural formula (I′), wherein in at least 10%, preferably at least 20%, more preferably at least 30%, yet more preferably at least 50%, yet more preferably at least 75%, most preferably at least 99% of all of the polymers P₁ according to structural formula (I′) comprised in the suspension S₁ provided in step (a) n′_{1 ≥99}, yet more preferably n′₁ ≥100.

### 2. Extruder E

The process according to the invention is performed in an extruder E.

Extruders are familiar to the skilled person and described for various chemical reactions and processes, for example in WO 2020/053051 A1 and EP 2 455 424 A1. An extruder is generally understood as being a machine which accommodates solid to liquid moulding materials, typically in an interior of the extruder, and presses these out of a product outlet (or “opening”) which is in particular a die, predominantly continuously as extrudate (according to DIN 24450:1987-02); see Somborn R, Extruder, RD-05-02432 (2004) in Böckler F., Dill B., Eisenbrand G., Faupel F., Fugmann B., Gamse T., Matissek R., Pohnert G., Ruhling A., Schmidt S., Sprenger G., RÖMPP [Online], Stuttgart, Georg Thieme Verlag, [December 2022]; retrievable online at https://roempp.thieme.de/lexicon/RD-05-02432, last retrieved 14 Jan. 2023.

The extruder E comprises two barrels G₁, G₂ and optionally a further barrel G₃. In the context of the invention “barrel” is understood as meaning sections in the interior of the extruder E in which the reaction conditions (in particular the temperature) may be adjusted independently of the remaining sections of the extruder.

Extruders additionally also comprise transporting means with which the content of the extruder may be transported from one barrel into the next and finally to the product outlet. In single- or multi-screw extruders this task is assumed for example by the screw elements.

In a preferred embodiment of the present invention the extruder E is selected from the group consisting of piston extruders, multi-screw extruders, wherein multi-screw extruders are particularly preferred. Preferred multi-screw extruders are planetary roller extruders or multi-screw extruders, in particular multi-screw extruders, more preferably twin-screw extruders.

In a preferred embodiment of the present invention an inert gas, for example nitrogen, is allowed to pass through the extruder E during the process according to the invention.

### 3. Step (a)

In step (a) of the process according to the invention a suspension S₁ comprising a continuous phase P_{Kon} and particles P_{Par} of the at least one polymer P₁ suspended in P_{Kon} is provided in the barrel G₁ and transported from the barrel G₁ into the barrel G₂.

In accordance with general knowledge in the art and in the context of the invention “suspension” means a composition comprising insoluble solids particles (also called “particles”; denoted by “P_{Par}” in the present invention) in a liquid continuous phase (denoted by “P_{Kon}” in the present invention); see also: RD-19-05060 (2002) in Böckler F., Dill B., Eisenbrand G., Faupel F., Fugmann B., Gamse T., Matissek R., Pohnert G., Rühling A., Schmidt S., Sprenger G., RÖMPP [Online], Stuttgart, Georg Thieme Verlag, [December 2022]; retrievable at https://roempp.thieme.de/lexicon/RD-19-05060; last retrieved 14 Jan. 2023).

In step (a) of the process according to the invention the at least one polymer P₁ is employed as a solid, namely in the form of particles P_{Par}, i.e. in the suspension S₁ according to the invention the at least one polymer P₁ is present in suspended form in the form of the particles P_{Par}.

This means that step (a) and preferably also step (b) are performed at a temperature that is below the melting temperature of the at least one polymer P₁.

In a preferred embodiment, at least 50%, in particular at least 90%, of the particles P_{Par} of the at least one polymer P₁ employed in step (a) have a size of at most 20 mm (“D90”), more preferably a value between 1 mm to 10 mm.

According to the invention the particle size distribution is determined by sieve analysis according to the standard DIN 66165-2:2016-08.

The process according to the invention is particularly suitable for processing wastes comprising the at least one polymer P₁. In this embodiment the wastes to be worked up in the process according to the invention may be comminuted before step (a) to allow particles P_{Par} of suitable size to be employed in step (a). This comminution is achieved by grinding for example.

In the suspension S₁ according to the invention provided in step (a) the continuous phase P_{Kon} is formed by the product of the depolymerization in step (c) as described hereinbelow.

In a preferred embodiment the proportion of the weight of all polymers P₁ in the suspension S₁ provided in step (a), based on the weight of the continuous phase P_{Kon}, in the suspension S₁ provided in step (a) is at least 1% by weight, preferably at least 5% by weight, preferably at least 10% by weight, more preferably at least 25% by weight.

In another embodiment the proportion of the weight of all polymers P₁ in the suspension S₁ provided in step (a), based on the total weight of the suspension S₁ provided in step (a), is in the range from 1% to 99% by weight, preferably in the range from 5% to 75% by weight, preferably in the range from 10% to 50% by weight, more preferably in the range from 10% to 40% by weight, more preferably in the range from 15% to 25% by weight.

Since the at least one polymer P₁ in the suspension S₁ which is provided in step (a) and transported from the barrel G₁ into the barrel G₂ is in particle form it goes without saying that step (a) of the process according to the invention is performed at a temperature Ta which is below the melting temperature T_{P1} of the at least one polymer P₁. According to the invention the “temperature Ta” is the temperature at which step (a) is performed.

When the at least one polymer P₁ is selected from PBT, PET and in particular P₁=PBT the temperature Ta is preferably in a range from 165° C. to 220° C., more preferably in the range from 170° C. to 220° C., yet more preferably in the range from 180° C. to 220° C., yet more preferably in the range from 190° C. to 210° C., most preferably in the range from 195° C. to 202° C.

When the at least one polymer P₁=PET the temperature Ta in another embodiment is preferably in a range from 130° C. to 255° C., more preferably in a range from 165° C. to 240° C., more preferably in a range from 165° C. to 220° C., yet more preferably in the range from 170° C. to 220° C., yet more preferably in the range from 180° C. to 220° C., more preferably in the range from 190° C. to 210° C., most preferably in the range from 195° C. to 202° C.

For PBT T_{P1}=223° C. For PET T_{P1}=260° C.

After providing the suspension S₁ in the barrel G₁ of the extruder E in step (a) of the process according to the invention the suspension S₁ is transported from the barrel G₁ into the barrel G₂. This may be done using the transport apparatuses known to those skilled in the art and customary in extruders, in particular screw elements, pistons, preferably screw elements.

### 4. Step (b)

In step (b) of the process according to the invention at least one glycol compound G is introduced into the barrel G₂ via at least one feed Ze and in the barrel G₂ at least partially reacted with the at least one polymer P₁ in the suspension S₁ to obtain a mixture M_{G2} comprising at least one cleavage product P₂.

The feed Z_{G} by means of which the at least one glycol compound G is introduced into the barrel G₂ may be selected by a person skilled in the art according to their knowledge in the art and may be configured as a valve, for example.

### 4.1 Glycol Compound G

The glycol compound G added in step (b) has the structural formula (V):

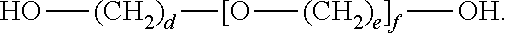

Here, d is an integer for which 2≤d≤6, in particular d=2 or 4, preferably d=2. Here, e is an integer for which 2≤e≤6, in particular e=2 or 4, preferably e=2.

Here, f is an integer for which 0≤f≤10, in particular f=0 or 1, preferably f=0.

It is preferable when the glycol compound G added in step (b) is selected from the group consisting of:
ethylene glycol (=ethane-1,2-diol; CAS-No.: 107-21-1; structural formula (V) where d=2, c=0);
butylene glycol (=butane-1,4-diol; CAS-No.: 110-63-4; structural formula (V) where d=4, c=0);
diethylene glycol [=2-(2-hydroxyethoxy) ethanol; CAS-No.: 111-46-6; structural formula (V) where d=2, e=2, f=1];
   wherein ethylene glycol is particularly preferred.

In a preferred embodiment of the present invention the glycol compound G added in step (b) is at least one of the products of the depolymerization according to the invention of the polymer P₁.

Thus the glycol compound G added in step (b) is preferably ethylene glycol when the polymer P₁ at least in part comprises segments of polyethylene terephthalate PET and yet more preferably when the polymer P₁ is PET.

Thus the glycol compound G added in step (b) is preferably butylene glycol when the polymer P₁ at least in part comprises segments of polybutylene terephthalate PBT (=“PBT”) and yet more preferably when the polymer P₁ is PBT.

### 4.2 Reaction Conditions in Step (b)

In step (b) of the process according to the invention at least one glycol compound G is introduced into the barrel G₂ via at least one feed Z_{G}. The reaction of at least a portion of the at least one polymer P₁ in the suspension S₁ with the at least one glycol compound G to obtain at least one cleavage product P₂, thus affording the mixture M_{G2} comprising at least one cleavage product P₂ after termination of step (b), is then carried out in the barrel G₂.

The reaction according to step (b) of the process according to the invention is performed in particular until the weight of all polymers P₁ in the mixture M_{G2} withdrawn at the product outlet E_{X} in step (c) has fallen by at least 10% by weight, preferably by at least 20% by weight, more preferably by at least 30% by weight, more preferably by at least 40% by weight, more preferably by at least 50% by weight, yet more preferably by at least 60% by weight, yet more preferably by at least 70% by weight, yet more preferably by at least 80% by weight, yet more preferably by at least 90% by weight, most preferably by at least 98% by weight, in each case based on the weight of all polymers P₁ in the suspension S₁ provided in step (a).

It is preferable when the water content in the mixture S₁ during the reaction according to step (b) and in the mixture M_{G2} obtained after termination of step (b) is as low as possible so that in the reaction according to step (b) of the glycol compound G with the polymer P₁ the proportion of solvolytic transesterification is as high as possible and the proportion of hydrolytic ester cleavage is as low as possible. These two different reactions are shown in the following scheme 1.

As is apparent from scheme 1 the polymer P₁ [shown in the middle via a segment from structural formula (l′)] upon reaction with G undergoes solvolytic transesterification to afford two cleavage products P₂ (bottom half of scheme 1). Here, the carboxylic acid groups of the termini of the two obtained cleavage products are esterified with G (last line of scheme 1, cleavage product P₂ left-hand side) or with the alkylene glycol unit present in P₁ (last line of scheme 1, cleavage product P₂ right-hand side). If the cleavage products P₂ are to be repolymerized to afford a polymer P₁ these ester groups allow easier conversion into the polymer P₁, thus making them advantageous cleavage products P₂. In the glycolysis of PET with ethylene glycol the desired diester bis(2-hydroxyethyl) terephthalic acid BHET is formed for example.

By contrast, the presence of water in the suspension S₁ during the reaction according to step (b) results in hydrolytic cleavage of the polymer P₁ and in the formation of disadvantageous cleavage products P₂.

This is shown in the top half of scheme 1. This results in two cleavage products P₂, one of which bears a free, i.e. unesterified, carboxylic acid group at the terminus (first line of scheme 1, cleavage product P₂ left-hand side). The conversion of such cleavage products P₂ into new polymers P₁ is costly and inconvenient and they are therefore disadvantageous. The hydrolysis of PET forms TS as the main product and also the monoester 2-hydroxyethyl terephthalate MHET.

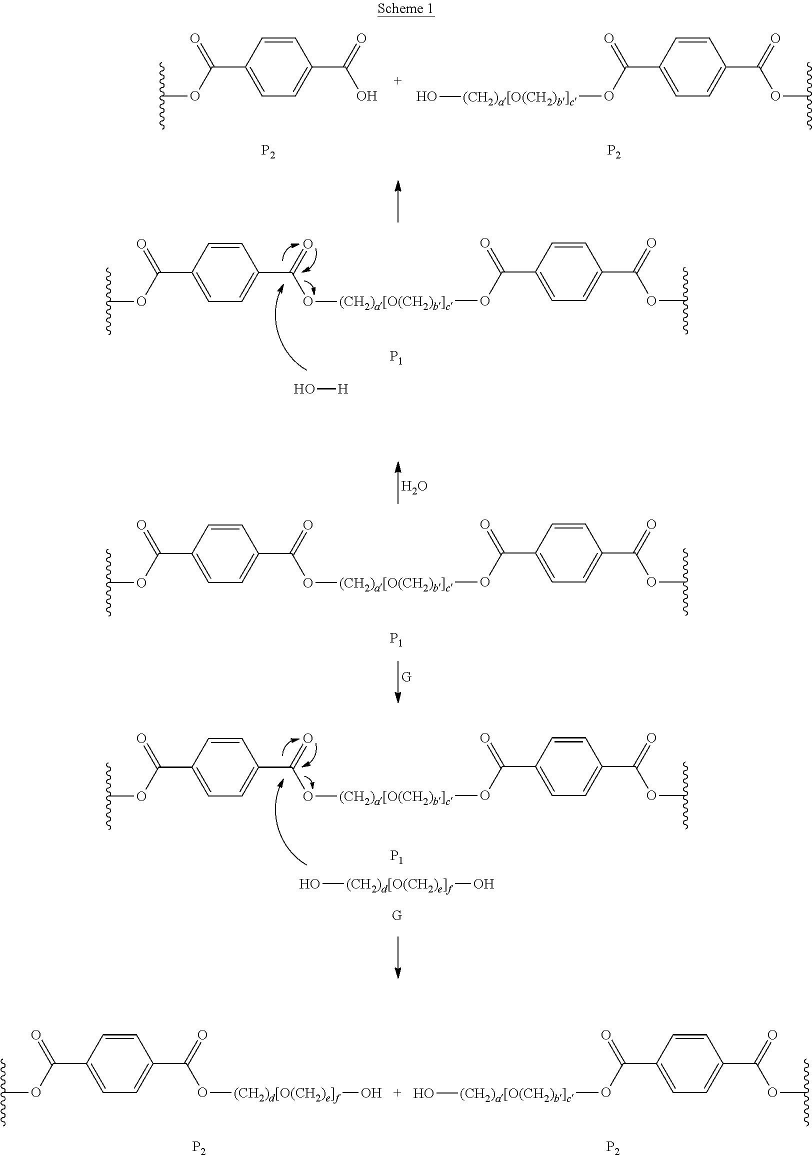

It is therefore advantageous to keep the water content in the suspension S₁ as low as possible during the reaction according to step (b).

In a preferred embodiment of the present invention the water content in the suspension S₁ during the reaction according to step (b) is therefore <10% by weight, more preferably <5% by weight, yet more preferably <1% by weight, yet more preferably <0.1% by weight, most preferably <0.01% by weight, in each case based on the total weight of the suspension S₁.

The proportion of the at least one glycol compound G added to the suspension S₁ in the barrel G₂ in step (b) is not further limited. It is advantageous when in step (b) the polymer P₁ is cleaved into the highest possible proportion of cleavage products P₂. This is advantageously controlled via the amount of at least one glycol compound G added to the suspension S₁ in step (b).

In a preferred embodiment of the process according to the invention the molar amount of all glycol compounds G introduced into the barrel G₂ in step (b) is ≥0.01 molar equivalents and is more preferably in the range from 0.1 to 50 molar equivalents, more preferably in the range from 0.3 to 40 molar equivalents, more preferably in the range from 0.5 to 20 molar equivalents, yet more preferably in the range from 1.0 to 15 molar equivalents, yet more preferably in the range from 2.0 to 10 molar equivalents, yet more preferably in the range from 3.0 to 5.0 molar equivalents, in each case based on the molar amount of all repeating units of structural formula (I) comprised by the polymers P₁ in the suspension S₁ provided in step (a).

The process according to the invention is preferably performed solvolytically to minimize the proportion of undesired products (such as TS or MHET in the case of hydrolysis of PET) in the reaction product as far as possible and to maximize the proportion of desired products (such as BHET in the case of solvolysis of PET with ethylene glycol) in the reaction product. It is therefore preferred when the water content in the glycol compounds G added in step (b) based on the total weight of all glycol compounds G added in step (b) is <10% by weight, more preferably <5% by weight, yet more preferably <1% by weight, yet more preferably <0.1% by weight, most preferably <0.01% by weight.

“T_{b}” means here the temperature during the reaction according to step (b).

The reaction in step (b) of the process according to the invention is performed at a temperature T_{b} in which the continuous phase P_{Kon} is in the liquid phase, i.e. in the form of a melt or solution, preferably in the form of a solution.

The temperature T_{b} may also be selected so that it is below or above the melting temperature T_{P1} of the at least one polymer P₁ during step (b). It is preferable when in step (b) the temperature T_{b} is below the melting temperature T_{P1} of the at least one polymer P₁. The at least one polymer P₁ is then present in particle form during step (b).

When the at least one polymer P₁ is selected from PBT, PET and in particular P₁=PBT the temperature T_{b} is preferably in a range from 165° C. to 220° C., more preferably in the range from 170° C. to 220° C., yet more preferably in the range from 180° C. to 220° C., yet more preferably in the range from 190° C. to 210° C., most preferably in the range from 195° C. to 202° C.

When the at least one polymer P₁=PET the temperature T_{b} in another embodiment is preferably in a range from 130° C. to 255° C., more preferably in a range from 165° C. to 240° C., more preferably in a range from 165° C. to 220° C., more preferably in the range from 170° C. to 220° C., yet more preferably in the range from 180° C. to 220° C., yet more preferably in the range from 190° C. to 210° C., most preferably in the range from 195° C. to 202° C.

### 4.3 Cleavage Product P₂

In step (b) of the process according to the invention at least a portion of the polymers P₁ comprised by the suspension S₁ are reacted with the at least one glycol compound G to afford at least one cleavage product P₂ in the barrel G₂. Step (b) accordingly affords a mixture M_{G2} comprising at least one cleavage product P₂.

The cleavage product P₂ has the structural formula (II):

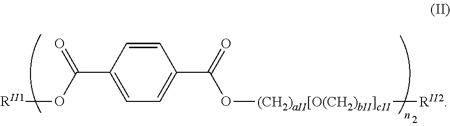

Here, a^{II} is an integer for which 2≤a^{II}≤6, in particular a^{II}=2 or 4, preferably a^{II}=2.

Here, b^{II} is an integer for which 2≤b^{II}≤6, in particular b^{II}=2 or 4, preferably b^{II}=2.

Here, c^{II} is an integer for which 0≤c^{II}≤10, in particular c^{II}=0 or 1, preferably c^{II}=0. Here, n₂ is an integer for which 1≤n₂≤48.

Structural formula (II) may also be expressed as “R^{II1}—(W₂)ₙ₂—R^{II2}”. W₂ thus conforms to the structure comprised in the parentheses indexed with “n₂” in structural formula (II):

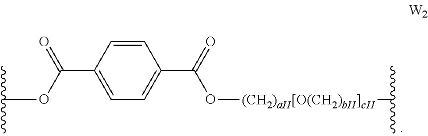

The repeating units W₂ interlinked within the cleavage product P₂ for 2≤n₂≤48 may be identical or different within the cleavage product P₂. This means for example that a molecule P₂ may comprise groups W₂ that are identical or different (i.e. have different values of a^{II}, b^{II} and/or c^{II} for example).

Here, R^{II1} is selected from the group consisting of —H, —( [symbol] —[O—( [symbol] —OH.

Here, [symbol] is an integer for which 2≤ [symbol] ≤6, in particular [symbol] =2 or 4, preferably [symbol] =2.

Here, [symbol] is an integer for which 2≤ [symbol] ≤6, in particular [symbol] =2 or 4, preferably [symbol] =2.

Here, [symbol] is an integer for which 0≤ [symbol] ≤10, in particular [symbol] =0 or 1, preferably [symbol] =0.

Here, R^{II2} is selected from the group consisting of —H, —OH, a radical of structural formula (IV), preferably selected from the group consisting of —OH, a radical of structural formula (IV), wherein structural formula (IV) is as follows:

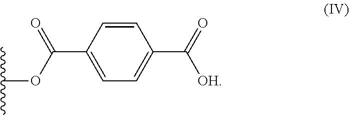

The cleavage products P₂ of structural formula (II), wherein a^{II}=2; c^{II}=0; [symbol] =2; [symbol] =0; 2≤n₂≤48; are according to the invention also referred to as “BHET oligomers” or “oligomers of BHET”.

The molar amount of cleavage product P₂ and of polymer P₁ in a particular mixture, in particular in the suspension S₁ or the mixture M_{G2}, is determinable by methods of measurement known to those skilled in the art. According to the invention the molecular weight distributions of the polymers P₁ and the cleavage products P₂ (and thus the average degree of polymerization p) are determined by gel permeation chromatography (“GPC”) according to method 1 (see examples section).

The content of compounds (III) in a particular mixture, in particular in the suspension S₁ or the mixture M_{G2}, is determinable via methods of measurement known to those skilled in the art, preferably via nuclear magnetic resonance (“NMR”) or chromatography.

Accordingly a mixture M_{G2} comprising at least one cleavage product P₂ is obtained after termination of step (b).

In a further preferred embodiment the proportion of the molar amount of all cleavage products P₂ which are comprised by the mixture M_{G2} at the product outlet E_{X} and comprise not more than 20 repeating units of structural formula W₂ based on the molar amount of all cleavage products P₂ comprised by the mixture M_{G2} is at least 25%, preferably at least 40%, more preferably at least 50%, yet more preferably at least 70%, yet more preferably at least 85%.

In a further preferred embodiment the proportion of the molar amount of all compounds of structural formula (III) comprised by the mixture M_{G2} at the product outlet E_{X} based on the molar amount of all cleavage products P₂ comprised by the mixture M_{G2} at the product outlet E_{X} is at least 10%, more preferably at least 25%, more preferably at least 30%, yet more preferably at least 50%, wherein structural formula (III) is as follows:

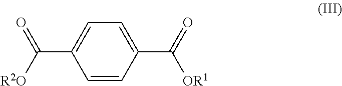

In structural formula (III) R¹ and R² are independently of one another selected from the group consisting of —H, —(CH₂)ₚ—[O—(CH₂)_{q}]—OH, wherein preferably at least one, more preferably both, of the radicals R¹ and R² are independently of one another in each case a radical of structural formula (CH₂)ₚ—[O(CH₂)_{q}]—OH.

It is yet more preferable when the radicals R¹ and R² are in each case the same radical of structural formula —(CH₂)ₚ—[O(CH₂)_{q}]ᵣ—OH.

Here, p is an integer for which 2≤p≤6, in particular p=2 or 4, preferably p=2.

Here, q is an integer for which 2≤q≤6, in particular q=2 or 4, preferably q=2.

Here, r is an integer for which 0≤r≤10, in particular r=0 or 1, preferably r=0.

### 4.4 Catalyst K

It is advantageous when the reaction of the glycol compound G with the polymer P₁ in suspension S₁ in step (b) is performed in the presence of at least one catalyst K.

Here, the catalyst K may for example be present in the suspension S₁ before introduction of the at least one glycol compound G into the barrel G₂ in step (b). It is preferable when the at least one catalyst K is introduced into the barrel G₂ together with the at least one glycol compound G in step (b).

The catalyst K may be selected by a person skilled in the art according to their knowledge in the art.

The catalyst K is preferably selected from the group consisting of carbonates, hydrogencarbonates, metal halides, amines, alkoxides, acetates, phosphates, dibutyltin oxide, more preferably selected from the group consisting of amines, alkoxides, acetates, yet more preferably the catalyst K is an alkoxide, yet more preferably an alkali metal alkoxide.

A preferred acetate is selected from the group consisting of lead acetate, zinc acetate, wherein zinc acetate is more preferred.

Preferred phosphates are alkali metal phosphates, in particular sodium phosphate.

A preferred metal halide is zinc chloride.

Preferred carbonates are alkali metal carbonates or alkaline earth metal carbonates, in particular alkali metal carbonates, preferably sodium carbonate.

Preferred hydrogencarbonates are alkali metal hydrogencarbonates or alkaline earth metal hydrogencarbonates, in particular alkali metal hydrogencarbonates, preferably sodium hydrogencarbonate.

Amines employed preferably include trialkylamines such as for example trimethylamine, triethylamine, dimethylethylamine, di(iso-propyl)ethylamine (“DIPEA”) or cyclic amines such as for example 1,5,7-triazabicyclo[4.4.0]dec-5-ene (“TBD”) or 1,8-diazabicyclo[5.4.0]undec-7-ene (“DBU”). These have the following structural formulae:

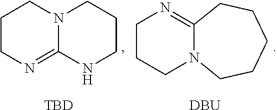

TBD is described in K. Fukushima, O. Coulembier, J. M. Lecuyer, H. A. Almegren, A. M. Alabdulrahman, F. D. Alsewailem, M. A. McNeil, P. Dubois, R. M. Waymouth, H. W. Horn, J. E. Rice, J. L. Hedrick, Journal of Polymer Science Part A: Polymer Chemistry 2011, 49, 1273-1281.

Trialkylamines, DBU and TBD were discussed in this context at the conference “Polyester Digestion: VOLCAT. Summit on Realizing the Circular Carbon Economy” on 24 Jul. 2018 by B. Allen, G. Breyta, J. Garcia, G. Jones, J. Hedrick in San Jose, California, USA (slides retrievable at https://www.energy.gov/sites/prod/files/2018/10/f56/Robert_Allen_CCE_PanelDayl_0.pdf; last retrieved 15 Jan. 2023).

If the catalyst K employed is an alkoxide, in particular an alkali metal alkoxide, this is preferably employed as a solid, for example in the form of a powder or granulate.

Preferred alkoxides are alkali metal alkoxides, wherein the alcohol is a monohydric or dihydric alcohol having 1 to 6 carbon atoms.

Yet more preferred alkali metal alkoxides are those wherein the alkoxide is selected from the group consisting of
methoxide;
ethoxide;
propoxide, wherein n-propoxide or iso-propoxide are concerned;
butoxide, in particular n-butoxide;
pentoxide, in particular n-pentoxide;
hexoxide, in particular n-hexoxide;
ethyleneglycolate;
more preferably selected from methoxide, ethoxide, ethyleneglycolate, yet more preferably selected from methoxide, ethoxide and most preferably is methoxide.

In the context of the invention “ethyleneglycolate” is understood as meaning the corresponding salt of ethylene glycol. According to the invention the term “M_{A} ethyleneglycolate”, wherein M_{A} is an alkali metal, comprises at least one of M_{A}O—CH₂—CH₂—OH and M_{A}O—CH₂—CH₂-OM_{A}, preferably at least M_{A}O—CH₂—CH₂—OH.

Preferred alkali metals here are sodium, potassium, more preferably sodium.

In a particularly preferred embodiment the catalyst K is selected from the group consisting of sodium ethyleneglycolate, potassium ethyleneglycolate, potassium methoxide, sodium methoxide, potassium ethoxide, sodium ethoxide, more preferably selected from the group consisting of potassium methoxide, sodium methoxide, potassium ethoxide, sodium ethoxide, more preferably selected from the group consisting of sodium methoxide, potassium ethoxide, sodium ethoxide, particularly preferably K=sodium methoxide.

The alkali metal alkoxide employable in the process according to the invention as catalyst K may be produced according to the knowledge of a person skilled in the art, for example by reactive distillation from the corresponding alcohol and the corresponding alkali metal hydroxide, as described in EP 1 997 794 A1, WO 01/42178 A1, WO 2021/148174 A1, WO 2021/148175 A1, WO 2022/117803 A1, WO 2022/167311 A1, WO 2022/263032 A1, EP 4 074 684 A1, EP 4 074 685 A1.

The alkali metal alkoxide employable in the process according to the invention as catalyst K may alternatively also be produced by transalcoholization from the corresponding alcohol and another alkoxide. A corresponding production of alkali metal alkoxides is described for example in CS 213 119 B1, GB 490,388 A, DE 689 03 186 T2 and EP 0 776 995 A1.

Transalcoholizations by reactive distillation, which likewise provide alkoxides, in particular alkali metal alkoxides, employable in the process according to the invention as catalyst K, are described in WO 2021/122702 A1, DE 27 26 491 A1, DE 1 254 612 B.

The alkoxides employable as catalyst K according to the invention may also be produced electrochemically as described for example in EP 3 885 470 A1, EP 3 885 471 A1, EP 4 043 616 A1, EP 4 112 778 A1, WO 2023/274796 A1, WO 2023/274794 A1.

The amount of the catalyst K employed in step (b) may be selected by a person skilled in the art according to their knowledge in the art. The molar amount of all catalysts K employed in step (b) based on the molar amount of all glycol compounds G employed in step (b) is in particular in the range from 0.01% to 10%, preferably in the range from 0.1% to 5%, more preferably in the range from 1% to 4%, yet more preferably in the range from 2.5% to 3.5%.

### 5. Step (c)

The reaction in step (b) affords a mixture M_{G2} comprising at least one cleavage product P₂. This mixture M_{G2} is transported to the product outlet E_{X} in step (c). The mixture M_{G2} is withdrawn at the product outlet E_{X}.

Suitable product outlet E_{X} includes any opening of the extruder E from which the mixture M_{G2} may be withdrawn. This product outlet E_{X} is typically located at the end of the extruder E.

In the embodiments where the extruder E comprises only the two barrels G₁ and G₂ the product outlet E_{X} typically follows the barrel G₂ so that the mixture is obtained directly after passing through the barrel G₂. In the embodiments where the extruder E comprises a further barrel G₃ in addition to the two barrels G₁ and G₂ the mixture M_{G2} is typically withdrawn after passing through the barrel G₃.

The reaction in step (b) in the process according to the invention is advantageously performed until the cleavage products P₂ make up the majority of the mixture M_{G2} withdrawn at the product outlet E_{X}. In a preferred embodiment of the present invention the proportion of all cleavage products P₂ in the mixture M_{G2} withdrawn at the product outlet E_{X} is at least 50% by weight, more preferably at least 60% by weight, yet more preferably at least 70% by weight, yet more preferably at least 80% by weight, yet more preferably at least 90% by weight, in each case based on the total weight of the mixture M_{G2} withdrawn at the product outlet E_{X}.

The constituents of the mixture M_{G2} withdrawn at the product outlet E_{X} that are distinct from the cleavage products P₂ are in particular selected from glycol compounds G, unconverted polymers P₁, preferably glycol compounds G.

In a further preferred embodiment the ratio of the weight (in grams) of all cleavage products P₂ in the mixture M_{G2} withdrawn at the product outlet E_{X} to the weight (in grams) of all polymers P₁ in the mixture M_{G2} withdrawn at the product outlet E_{X} is >1:1, more preferably >2:1, yet more preferably >3:1, yet more preferably >4:1, yet more preferably >10:1, yet more preferably >30:1, yet more preferably >100:1, yet more preferably >1000:1.

In a further preferred embodiment the proportion of the portion of the mixture M_{G2} employed in step (a) as continuous phase P_{Kon} of the suspension S₁ based on the total weight of the mixture M_{G2} withdrawn at the product outlet E_{X} of the extruder E is in the range from 1% to 99% by weight, preferably in the range from 10% to 90% by weight, more preferably in the range from 20% to 80% by weight, yet more preferably in the range from 30% to 70% by weight, yet more preferably in the range from 40% to 60% by weight, most preferably 50% by weight.

In an optional embodiment of the process according to the invention the extruder E comprises a further barrel G₃ through which the mixture M_{G2} passes during transport from the barrel G₂ to the product outlet E_{X}. This embodiment is advantageous if the reaction is not sufficiently advanced in barrel G₂ and is completed before the product outlet E_{X}. For example, a postreaction may then be carried out in barrel G₃, optionally at a temperature elevated or reduced relative to the temperature in G₂, or the mixture M_{G2} may be allowed to cool in barrel G₃.

### 6. Characterizing Feature of the Process According to the Invention

The process according to the invention is characterized in that a portion of the mixture M_{G2} withdrawn at the product outlet E_{X} is employed in step (a) as continuous phase P_{Kon} of the suspension S₁.

It has surprisingly been found that this establishes an equilibrium in the process according to the invention which minimizes pressure spikes and an inhomogeneous process mode.

A contributing factor to assisting this effect is that in step (a) the suspension S₁ is provided in barrel G₁ and the at least one glycol compound G is introduced only in barrel G₂.

The at least one continuous phase P_{Kon} withdrawn as mixture M_{G2} at the product outlet E_{X} and employed in step (a) as continuous phase P_{Kon} of the suspension S₁ is preferably a solution of the cleavage products P₂ in the at least one glycol compound G.

In a preferred embodiment the ratio of the volume of the suspension S₁ in the extruder E upstream of the at least one feed Z_{G} of the at least one glycol compound G into the barrel G₂ to the sum of the volumes of the suspension S₁ and the mixture M_{G2} from the at least one feed Z of the at least one glycol compound G into the barrel G₂ to the product outlet E_{X} is in the range from 1:99 to 99:1, more preferably in the range from 1:9 to 9:1, yet more preferably in the range from 1:4 to 4:1, yet more preferably in the range from 2:3 to 3:2, yet more preferably 1:1.

The corresponding volumes, i.e.
“volume of the suspension S₁ in the extruder E upstream of the at least one feed Z_{G} of the at least one glycol compound G into the barrel G₂” (“Uᵤₚ” for short); and
“the sum of the volumes of the suspension S₁ and the mixture M_{G2} from the at least one feed Z_{G} of the at least one glycol compound G into the barrel G₂ to the product outlet E_{X}” (“U_{down}” for short),
are determinable according to the invention by the following test:
1. The extruder E is oriented such that the product outlet E_{X} occupies the lowest position.
2. The product outlet E_{X} and all feeds and outputs of the extruder E between the product outlet E_{X} and the uppermost feed, used in the process according to the invention as feed Z_{G}, are watertightly blocked.
3. The extruder E is filled with water until it overflows at the unblocked feed Z_{G}. The volume of water in the extruder E is then determined. This volume is U_{down}.
4. Now the product outlet E_{X} and all feeds and outputs of the extruder E between product outlet E_{X} and the uppermost feed Z_{O} are watertightly blocked.

If in the process according to the invention P₁ and the mixture M_{G2} are added to G₁ as mixture M_{X}, Z_{O} is the uppermost feed of this mixture M_{X}.

If in the process according to the invention P₁ is added to G₁ via at least one feed Z_{P1} and the mixture M_{G2} is added to G₁ separately via at least one feed Z_{PK}, Z_{O} is the uppermost feed of all feeds Z_{P1}, Z_{PK}.

5. The extruder E is filled with water until it overflows at the unblocked feed Z_{O}. The volume of water in the extruder E is then determined. This volume is Uᵤₚ+U_{down}. The difference between this value and U_{down} gives Uₙᵤₚ.

The following examples are intended to illustrate the invention.

### EXAMPLES

### Comparative Example 1

Comminuted PET flakes are metered gravimetrically and at 70° C. drawn into a barrel G₀ (process space) of an extruder having a plurality of barrels (i.e. sections whose wall temperature can be separately adjusted).

The PET flakes are transported from the barrel G₀ into a barrel G₁ in which the temperature has been raised to 265° C., thus melting the metered PET flakes. From the barrel G₁ the PET melt is transported into a barrel G₂ where a 4% by weight solution of sodium ethyleneglycolate in ethylene glycol is injected. The mass flow ratio of sodium ethyleneglycolate solution to PET is 0.5. The temperature of the barrel G₂ directly downstream of the injection point is likewise 265° C. and is reduced to 130° C. towards the extruder outlet. Discharged at the outlet of the extruder is a mixture comprising the main components BHET, BHET oligomers (corresponds to polymers P₂ for which n₂₌₂ to 48) and ethylene glycol. The pulsing discharge of ethylene glycol vapour is observed at irregular intervals.

### Comparative Example 2

Comminuted PET flakes are metered gravimetrically and at 70° C. drawn into a barrel G₀ (process space) of the extruder used in comparative example 1.

The PET flakes are transported from the barrel G₀ into a barrel G₁ in which the temperature has been raised to 195° C. From there, the PET flakes are transported to the extruder outlet at a barrel temperature of 195° C. without addition of ethylene glycol or sodium ethyleneglycolate.

Although the barrel temperature of the extruder does not exceed 195° C. and is thus below the melting temperature of PET the PET flakes are heated and melted by friction, with the result that they are discharged from the extruder as agglomerates.

### Inventive Example

Comparative example 1 is repeated with the following changes:

The temperature of the barrel G₁ is adjusted to 195° C. In addition to the comminuted PET flakes a portion of the mixture withdrawn at the extruder outlet (“M_{G2}” for short) having a residual content of ethylene glycol of 9% by weight is supplied to the barrel G₁ of the extruder E. The mass flow of M_{G2} is 20% by weight, based on the mass flow of the employed PET flakes.

This creates a suspension S₁ which on account of the lower melting point of the cleavage products P₂ in the continuous phase is already amenable to further processing at a temperature of the barrel G₁ of 195° C. Since the barrel temperature of 195° C. is below the melting temperature of PET (260° C.) the PET flakes are present in the continuous phase in solid form. The suspension S₁ is transported towards the extruder outlet and a solution of 15% by weight sodium ethyleneglycolate in ethylene glycol is injected in a second barrel G₂. The mass flow ratio of sodium ethyleneglycolate solution to PET is 0.1. The barrel temperature in the second barrel G₂ directly downstream of the injection point is likewise 195° C. and is reduced to 130° C. towards the extruder outlet. At the outlet of the extruder a highly viscous, pasty mixture comprising the main components BHET, BHET oligomers and ethylene glycol is discharged. The composition corresponds to the content of BHET and oligomeric BHET with a residual content of ethylene glycol metered in at the extruder inlet. A pulsing discharge of ethylene glycol is not observable.

### Result

The use of a suspension of PET in BHET and/or BHET oligomers, which represent the recycled extruder output, makes it possible to reduce the process temperature, thus allowing a stable, efficient depolymerization of the PET. The pulsations that are questionable from a safety standpoint and occur in the conventional processes are absent. An efficient, safe process for depolymerization of polyalkylene terephthalates, in particular PET and PBT, is thus possible.

### Analysis

According to the invention the molecular weight distributions of the polymers P₁ and the cleavage products P₂ (and hence in each case the average degree of polymerization p in a given mixture) are determined by gel permeation chromatography (“GPC”) as per the following method 1. Method 1 is based on the methodology on page 356 of the article M. R. Milana, M. Denaro, L. Arrivabene, A. Maggio, L. Gramiccioni, Food Additives and Contaminants, 1998, 15, 355-361.

### Method 1

1. A sample of the mixture to be examined is diluted in the weight ratio of 1:333 in 1,1,1,3,3,3-hexafluoro-2-propanol (“HFIP”) and dissolved at room temperature for 24 hours.
2. The solution is filtered through a 1 μm disposable polytetrafluoroethylene filter and injected with an autosampler for analysis.
3. The following system for size exclusion chromatography (“GPC”) was used:
Eluent: HFIP/0.05 M KTFAc (=potassium trifluoroacetate)
Precolumn: PSS PFG, 7 μm, guard, ID 8.00 mm×50.00 mm
Columns: PSS PFG, 7 μm, 100 Å, ID 8.00 mm×300.00 mm
   PSS PFG, 7 μm, 100 Å, ID 8.00 mm×300.00 mm
   PSS PFG, 7 μm, 300 Å, ID 8.00 mm×300.00 mm
Pump: PSS-SECcurity 1260 HPLC pump
Flow rate: 1.0 ml/min
Injection system: PSS-SECcurity 1260 Autosampler
Injected volume: 50 μl
Sample concentration: 3.0 g/L
Temperature: 30° C.
Detectors: SECcurity² differential refractometer detector (RI)
Evaluation: PSS-WinGPC UniChrom Version 8.4
4. Calibration is effected by means of a PMMA standard (PMMA=polymethylmethacrylate) in the separation region of the column combination. The molar mass averages and the distribution thereof, which give the average degree of polymerization p in a given mixture, are calculated with computer assistance and are based on PMMA calibration by the strip method.

1-15. (canceled)

16. A process for depolymerization of at least one polymer P₁ in an extruder E, said extruder comprising a product outlet E_{X}, two barrels G₁, G₂ and optionally a further barrel G₃,
wherein the at least one polymer P₁ comprises n₁ interlinked repeating units of structural formula (I): 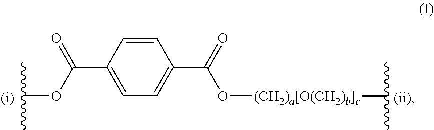
wherein a is an integer for which 2≤a≤6,
wherein b is an integer for which 2≤b≤6,
wherein c is an integer for which 0≤c≤10,
wherein n₁ is an integer ≥50,
wherein the n₁ interlinked repeating units of structural formula (I) comprised by the polymer P₁ are identical or different,
and wherein the n₁ interlinked repeating units of structural formula (I) are interlinked within the polymer P₁ in such a way that the bond of the one repeating unit of structural formula (I) labelled (i) is linked to the bond of the adjacent repeating unit of structural formula (I) labelled (ii),
said process comprising the following steps:
(a) a suspension S₁ comprising a continuous phase P_{Kon} and particles P_{Par} of the at least one polymer P₁ suspended in P_{Kon} is provided in the barrel G₁ and transported from the barrel G₁ into the barrel G₂;
(b) at least one glycol compound G having structural formula (V): HO—(CH₂)_{d}—[O—(CH₂)ₑ]_{f}—OH,
wherein d is an integer for which 2≤d≤6,
wherein e is an integer for which 2≤e≤6,
wherein f is an integer for which 0≤f≤10,
is introduced into the barrel G₂ via at least one feed Z_{G} and in the barrel G₂ at least partially reacted with the at least one polymer P₁ in the suspension S₁ to obtain a mixture M_{G2} comprising at least one cleavage product P₂,
wherein the cleavage product P₂ has the structural formula (II): 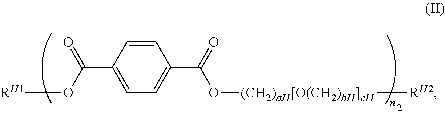
wherein a^{II} is an integer for which 2≤a^{II}≤6,
wherein b^{II} is an integer for which 2≤b^{II}≤6,
wherein c^{II} is an integer for which 0≤c^{II}≤10,
wherein n₂ is an integer for which 1≤n₂≤48,
wherein units W₂ are interlinked within the cleavage product P₂ for 2≤n₂≤48, and wherein each unit W₂ conforms to the structure in the parentheses indexed with “n₂” in structural formula (II), and the units W₂ are identical or different within the cleavage product P₂,
wherein R^{II1} is selected from the group consisting of —H, and — [symbol] —[O—( [symbol] —OH,
wherein [symbol] is an integer for which 2≤ [symbol] ≤6,
wherein [symbol] is an integer for which 2≤ [symbol] ≤6,
wherein [symbol] is an integer for which 0≤ [symbol] ≤10,
wherein R^{II2} is selected from the group consisting of —H, —OH, and a radical of structural formula (IV): 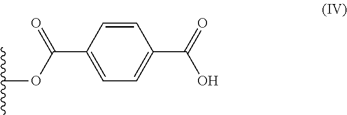
(c) the mixture M_{G2} is transported to the product outlet E_{X}, wherein said mixture optionally passes through a further barrel G₃, and is then withdrawn at the product outlet E_{X},
wherein:
a portion of the mixture M_{G2} withdrawn at the product outlet E_{X} is employed in step (a) as continuous phase P_{Kon} of the suspension S₁.

17. The process of claim 16, wherein the water content in the suspension S₁ during the reaction of step (b) is <10% by weight based on the total weight of S₁.

18. The process of claim 16, wherein the ratio of the volume of suspension S₁ in the extruder E upstream of the feed Z_{G} to the combined volume of suspension S₁ and mixture M_{G2} between the feed Z_{G} and the product outlet E_{X} is in the range from 1:99 to 99:1.

19. The process of claim 16, wherein the proportion of all cleavage products P₂ in the mixture M_{G2} withdrawn at the product outlet E_{X} is at least 50% by weight based on the total weight of the mixture M_{G2} withdrawn at the product outlet E_{X}.

20. The process of claim 16, wherein the reaction of the glycol compound G with the polymer P₁ in the suspension S₁ in step (b) is performed in the presence of at least one catalyst K.

21. The process of claim 20, wherein the catalyst K is selected from the group consisting of carbonates, hydrogencarbonates, metal halides, amines, alkoxides, acetates, phosphates, and dibutyltin oxide.

22. The process of claim 20, wherein the at least one catalyst K is introduced into the barrel G₂ together with the at least one glycol compound G in step (b).

23. The process of claim 16, wherein the molar amount of all glycol compounds G introduced into the barrel G₂ in step (b) is ≥0.01 molar equivalents based on the molar amount of all repeating units of structural formula (I) comprised by the polymers P₁ in the suspension S₁ provided in step (a).

24. The process of claim 16, wherein the ratio of the weight of all cleavage products P₂ in the mixture M_{G2} withdrawn at the product outlet E_{X} to the weight of all polymers P₁ in the mixture M_{G2} withdrawn at the product outlet E_{X} is >1:1.

25. The process of claim 16, wherein compounds of structural formula (III) constitute at least 10% of the molar amount of all cleavage products P₂ in the mixture M_{G2} at the product outlet E_{X}, wherein structural formula (III) is as follows: 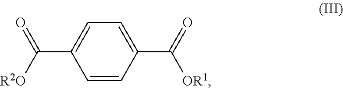
wherein R¹ and R² are independently of one another selected from the group consisting of —H, and —(CH₂)ₚ—[O(CH₂)_{q}]ᵣ—OH,
wherein p is an integer for which 2≤p≤6,
wherein q is an integer for which 2≤q≤6,
wherein r is an integer for which 0≤r≤10.

26. The process of claim 16, wherein the proportion of the portion of the mixture M_{G2} employed in step (a) as continuous phase P_{Kon} of the suspension S₁ based on the total weight of the mixture M_{G2} withdrawn at the product outlet E_{X} of the extruder E is in the range from 1% to 99% by weight.

27. The process of claim 16, wherein the at least one polymer P₁ is selected from the group consisting of polyethylene terephthalate PET, and polybutylene terephthalate PBT.

28. The process of claim 27, wherein the at least one polymer P₁ is polyethylene terephthalate PET.

29. The process of claim 28, wherein step (a) is performed at a temperature Ta in the range from 130° C. to 255° C.

30. The process of claim 28, wherein step (b) is performed at a temperature T_{b} in the range from 130° C. to 255° C.

31. The process of claim 17, wherein the ratio of the volume of suspension S₁ in the extruder E upstream of the feed Z_{G} to the combined volume of suspension S₁ and mixture M_{G2} between the feed Z_{G} and the product outlet E_{X} is in the range from 1:99 to 99:1.

32. The process of claim 18, wherein the proportion of all cleavage products P₂ in the mixture M_{G2} withdrawn at the product outlet E_{X} is at least 50% by weight based on the total weight of the mixture M_{G2} withdrawn at the product outlet E_{X}.

33. The process of claim 19, wherein the reaction of the glycol compound G with the polymer P₁ in the suspension S₁ in step (b) is performed in the presence of at least one catalyst K.

34. The process of claim 20, wherein the catalyst K is selected from the group consisting of carbonates, hydrogencarbonates, metal halides, amines, alkoxides, acetates, phosphates, and dibutyltin oxide.

35. The process according to claim 34, wherein the at least one catalyst K is introduced into the barrel G₂ together with the at least one glycol compound G in step (b).
